(19) United States
(12) Patent Application Publication
(10) Pub. No.: US 2013/0148733 A1
(43) Pub. Date: Jun. 13, 2013

(54) MOTION ESTIMATION APPARATUS AND METHOD

(71) Applicants: Seong Mo PARK, Daejeon (KR); Nak Woong Eum, Daejeon (KR); Hee-Bum Jung, Daejeon (KR)

(72) Inventors: Seong Mo PARK, Daejeon (KR); Nak Woong Eum, Daejeon (KR); Hee-Bum Jung, Daejeon (KR)

(73) Assignee: ELECTRONICS AND TELECOMMUNICATIONS RESEARCH INSTITUTE, Daejeon (KR)

(21) Appl. No.: 13/556,497

(22) Filed: Jul. 24, 2012

(30) Foreign Application Priority Data
Dec. 13, 2011 (KR) 10-2011-0133944

(51) Int. Cl. H04N 7/32

(52) U.S. Cl. 375/240.16; 375/E07.243

(57) ABSTRACT

Disclosed are motion estimation apparatus and method. The present invention can reduce an external memory access in an area in which a macroblock is large while preventing image quality from deteriorating due to motion estimation according to coding units, by obtaining a minimum motion vector using a prediction method in 64×64 and 32×32 modes for the coding units meeting a high efficiency video coding (HEVC) standard and obtaining a motion vector using a full search method in other modes.

### CROSS-REFERENCES TO RELATED APPLICATIONS

The present application claims priority under 35 U.S.C 119(a) to Korean Application No. 10-2011-0133944, filed on Dec. 13, 2011, in the Korean Intellectual Property Office, which is incorporated herein by reference in its entirety set forth in full.

### BACKGROUND

Exemplary embodiments of the present invention relate to motion estimation apparatus and method, and more particularly, to motion estimation apparatus and method suitable for ultra-high definition resolution at the time of estimating a motion of moving pictures according to a high efficiency video coding (HEVC) standard.

With the rapid development of information communication technologies, the research and development of a video conference system, a Wibro, next-generation mobile communications, high-quality wireless LAN, and the like, have been progressed and the interest and demand for high-speed multimedia data communications have been increased. Among the multimedia data communications, a field that currently receives the most attraction is transmission and reception of various types of information through a wireless network.

As a transmission rate of wireless data transmission and reception is rapidly improved currently, large-capacity moving picture data may also be transmitted and received in real time through a wireless communication network.

However, since the moving picture data have excellent information transfer capability but considerable large capacity, it is difficult to store and transmit the moving picture data. In addition, according to the demand of applications, a large amount of moving picture information needs to be appropriately processed and therefore, a system for processing moving pictures also requires a high specification. As methods for solving the problems, a moving picture compression algorithm that is a technology of converting the moving picture data into small information has been actively researched. As a representative international standard relating to moving picture compression that has been researched up to now, there are an MPEG series of ISO/IEC and an H.26x series of ITU-T.

Further, the high efficiency video coding (HEVC) that is a next-generation multimedia moving picture compression standard has been standardized to achieve a compression rate two times higher than that of the H.264. The standard relates to an implementation of a very high compression rate as a main technical target and is a general-purpose moving picture encoding technology that may be used in environment of almost all transmission media and various moving picture resolutions such as a storage medium, the Internet, satellite broadcasting, and the like.

In particular, in a motion estimation block having the most calculations among component blocks of the HEVC, the standard has been established using various coding units.

Data transmission between an external memory and an internal memory is frequently generated coping with an increase in resolution at the time of implementing a system on a chip (SoC) capable of processing ultra-high definition resolution as a HEVC based SoC as needed in the current market, which may lead to degradation in performance.

A background art of the present invention is disclosed in Korean Patent Laid-Open Publication No. 10-2009-0079286 (Jul. 22, 2009).

A large amount of memory bandwidth may occur by estimating macroblocks for current and previous pictures in a structure in which the HEVC that is a next-generation standard satisfies an ultra-high definition standard when implementing the motion estimation method using a fast full search block matching algorithm in the HEVC based SoC.

The above-mentioned technical configuration is a background art for helping understanding of the present invention and does not mean related arts well known in a technical field to which the present invention pertains.

### SUMMARY

An embodiment of the present invention is directed to motion estimation apparatus and method capable of reducing a memory access while preventing image quality from deteriorating due to motion estimation according to coding units, by obtaining a minimum motion vector using a prediction method in 64×64 and 32×32 modes for the coding units meeting a high efficiency video coding (HEVC) standard and obtaining motion vectors using a full search method in other modes.

An exemplary embodiment of the present invention relates to a motion estimation apparatus, including: a calculation unit configured to calculate sum of absolute difference (SADs) and motion vectors based on current pictures and previous pictures; a compensation intermediate calculation unit configured to calculate and output intermediate motion vectors for the current pictures and the previous pictures; and a control unit configured to control the calculation unit and the intermediate compensation calculation unit according to modes of coding units and perform a control to optionally output the motion vectors or the intermediate motion vectors according to output results of the compensation intermediate calculation unit.

The control unit may control the compensation intermediate calculation unit when the coding units are 64×64 and 32×32 modes.

The compensation intermediate calculation unit may include: a compensation unit configured to compensate for motions for the current pictures and calculate a compensation SAD; an intermediate value calculation unit configured to calculate an intermediate SAD and intermediate motion vectors using SADs and intermediate values of motion vectors for macroblocks neighboring to macroblocks of the current pictures and macroblocks of the previous pictures; and a comparison unit configured to output results obtained by comparing the intermediate SAD calculated by the intermediate value calculation unit with the compensation SAD calculated by the compensation unit, and to output the intermediate motion vectors calculated by the intermediate value calculation unit.

The comparison unit may output the intermediate motion vectors when the compensation SAD is smaller than the intermediate SAD.

The control unit may control to output the intermediate motion vector output from the comparison unit when the compensation SAD is smaller than the intermediate SAD according to the comparison results of the comparison unit.

The neighboring macroblocks may include a left portion, a top portion, and a top right portion of the macroblock of the current picture.

The control unit may read macroblock data or search area full data as the current pictures and the previous pictures according to the coding units.

Another exemplary embodiment of the present invention relates to a motion estimation method, including: receiving, by a control unit, modes of coding units to determine what modes are set so as to read macroblock data or search area full data for current pictures and previous pictures; calculating motion compensation and a compensation SAD for the macroblock data of the current pictures when the modes of the coding units are the set modes; calculating an intermediate SAD and intermediate motion vectors using SADs and intermediate values of motion vectors for macroblocks neighboring to macroblocks of the current pictures and macroblocks of the previous pictures; and outputting the intermediate motion vectors if it is determined that the compensation SAD is smaller according to results obtained by comparing the compensation SAD with the intermediate SAD.

The motion estimation method may further include: calculating and outputting the SADs and the motion vectors based on the search area full data when the modes of the coding units are modes other than the set modes and the compensation SAD is larger according to results obtained by comparing the compensation SAD with the intermediated SAD.

The set modes may be 64×64 and 32×32 modes.

The neighboring macroblocks may include a left portion, a top portion, and a top right portion of the macroblock of the current picture.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram illustrating a motion estimation apparatus in accordance with an embodiment of the present invention;

FIG. 2 is a diagram illustrating a coding unit in an HEVC standard to which the motion estimation apparatus in accordance with an embodiment of the present invention is applied;

FIG. 3 is a diagram for describing positions of neighboring macroblocks in a motion estimation apparatus in accordance with the embodiment of the present invention; and

FIG. 4 is a flow chart for describing a motion estimation method in accordance with the embodiment of the present invention.

### DESCRIPTION OF SPECIFIC EMBODIMENTS

Hereinafter, motion estimation apparatus and method in accordance with an embodiment of the present invention will be described with reference to the accompanying drawings. During the process, a thickness of lines, a size of components, or the like, illustrated in the drawings may be exaggeratedly illustrated for clearness and convenience of explanation. Further, the following terminologies are defined in consideration of the functions in the present invention and may be construed in different ways by intention or practice of users and operators. Therefore, the definitions of terms used in the present description should be construed based on the contents throughout the specification.

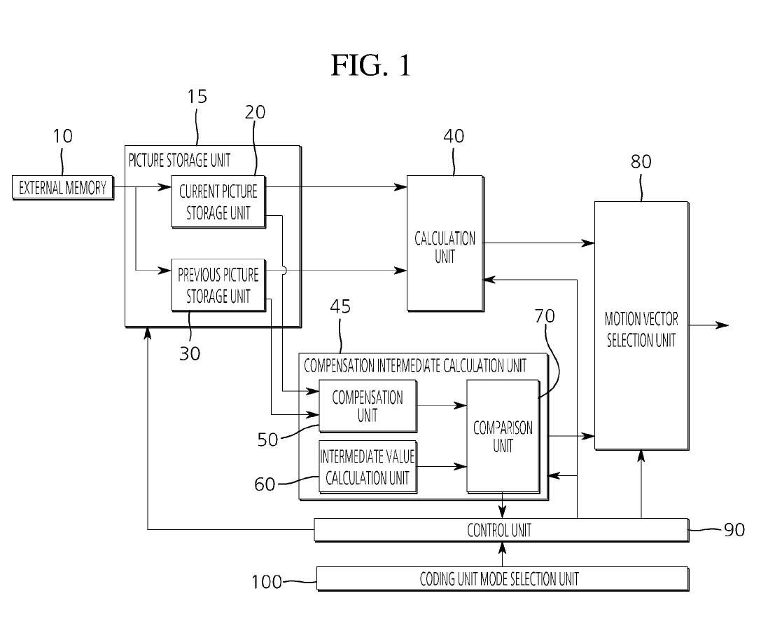

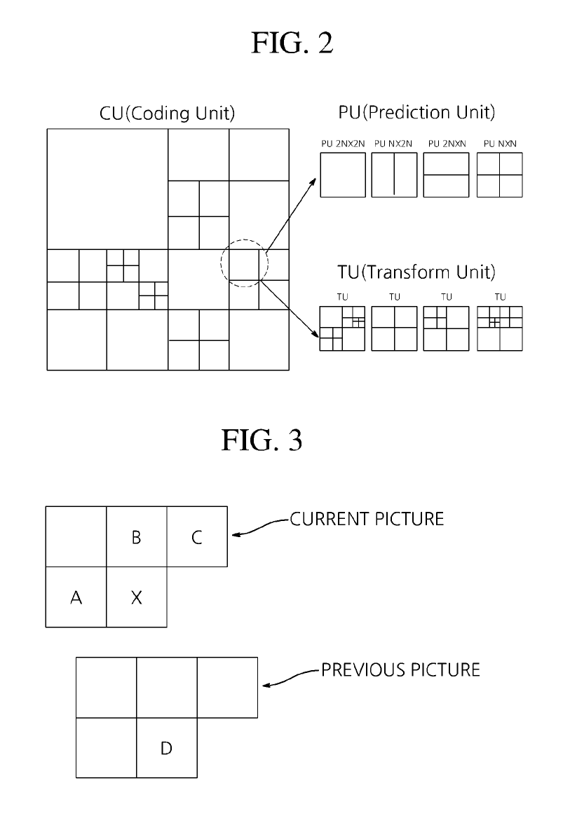

FIG. 1 is a block configuration diagram illustrating a motion estimation apparatus in accordance with an embodiment of the present invention, FIG. 2 is a diagram illustrating coding units in an HEVC standard to which the motion estimation apparatus in accordance with an embodiment of the present invention is applied, and FIG. 3 is a diagram for describing positions of neighboring macroblocks in a motion estimation apparatus in accordance with the embodiment of the present invention.

As illustrated in FIG. 1, a motion estimation apparatus in accordance with an embodiment of the present invention may include a picture storage unit 15, a calculation unit 40, a compensation intermediate calculation unit 45, a motion vector selection unit 80, and a control unit 90.

The picture storage unit 15 stores current pictures and previous pictures that are read from an external memory 10. In this case, the current pictures that are read from the external memory 10 are stored in a current picture storage unit 20 and the previous pictures are stored in the previous picture storage unit 30.

In this case, a control unit 90 may read macroblock data or search area full data as the current pictures and the previous pictures according to modes of the coding units.

As illustrated in FIG. 2, the HEVC standard uses various coding units and a size of macroblocks is variously configured according to the modes of the coding units.

The calculation unit 40 calculates sum of absolute differences (SADs) and motion vectors based on the current pictures and the previous pictures.

In this case, the calculation unit 40 applies a motion estimation algorithm used in the H.264 standard to calculate the SADs and the motion vectors based on the search area full data.

The compensation intermediate calculation unit 45 includes a compensation unit 50, an intermediate value calculation unit 60, and a comparison unit 70 to calculate and output intermediate motion vectors for macroblocks neighboring to macroblocks of the current pictures and macroblocks of the previous pictures.

In this case, the compensation unit 50 compensates for motions using only the macroblock data of the current pictures to calculate a compensation SAD (SADmcp) when the modes of the coding units are 64×64 and 32×32 modes in the HEVC standard to which the embodiment of the present invention is applied.

The intermediate value calculation unit 60 calculates an intermediate SAD (SADmed) and an intermediate motion vector (MVmed) using the SADs and the intermediate value of the motion vectors for the macroblocks neighboring to the macroblocks of the current pictures and the macroblocks of the previous pictures.

In this case, the neighboring macroblocks include a left portion A, a top portion B, and a top right portion C of a macroblock X.

Therefore, the intermediate SAD (SADmed) that is an intermediate value of each SAD for the left portion A, the top portion B, the top right portion C, and a macroblock D of the previous picture and an intermediate motion vector (MVmed) that is an intermediate value of each motion vector.

The comparison unit 70 compares the intermediate SAD (SADmed) calculated by the intermediate value calculation unit 60 with the compensation SAD (SADmcp) calculated by the compensation unit 50 to output comparison results and the intermediate motion vector (MVmed) calculated by the intermediate value calculation unit 60.

The motion vector selection unit 80 optionally outputs the motion vectors output from the calculation unit 40 and the intermediate motion vector (MVmed) output from the comparison unit 70.

The control unit 90 controls the calculation unit 40 and the compensation intermediate calculation unit 45 according to the modes of the coding units input from a coding unit mode selection unit 100 to select the output of the motion vector selection unit 80 according to the results of the compensation intermediate calculation unit 45.

That is, the control unit 90 compensates for the motions using only the macroblock data of the current pictures, calculates the compensation SAD (SADmcp), and compares the calculated compensation SAD (SADmcp) with the intermediate SAD (SADmed) calculated by the intermediate value calculation unit 60 when the modes of the coding units are the 64×64 and 32×32 modes to estimate the motions using the intermediated motion vector (MVmed) calculated by the intermediate value calculation unit 60 when the compensation SAD (SADmcp) is small.

On the other hand, when the modes of the coding units are 16×16 and 8×8 modes or the compensation SAD (SADmcp) is not smaller than the intermediate SAD (SADmed), the motion is estimated by calculating the motion vectors based on the search area full data as in the H.264 standard.

As described above, the motion estimation apparatus in accordance with the embodiment of the present invention can calculate the SADs for only the macroblocks of the current pictures when the modes of the coding units are the 64×64 and 32×32 modes to determine early termination and estimate the motions using the intermediate motion vectors to minimize an area of hardware and reduce a memory access.

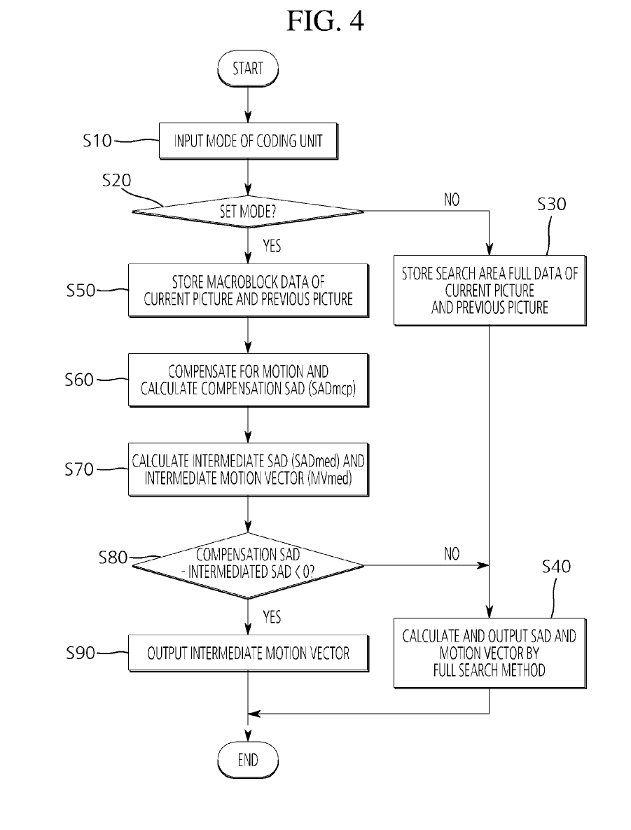

FIG. 4 is a flow chart for describing a motion estimation method in accordance with the embodiment of the present invention.

As illustrated in FIG. 4, the motion estimation method in accordance with the embodiment of the present invention first receives, by the control unit 90, the modes of the coding units from the coding unit mode selection unit 100 to determine what modes are set (S10) (S20).

In this case, the set modes are the 64×64 and 32×32 modes and various modes in addition to the 16×16 mode are applied in the HEVC standard, unlike the H.264 standard.

Therefore, when the modes set by the coding units are the 64×64 and 32×32 modes, only the macroblock data for the current pictures and the previous pictures are read from the external memory 10 and stored in the current picture storage unit 20 and the previous picture storage unit 30, thereby reducing the memory access (S50).

However, in the case of the modes in addition to the set modes, the search area full data are read from the external memory 10 and stored in the current picture storage unit 20 and the previous picture storage unit 30 (S30).

In the case other than the modes set later, the SADs and the motion vectors are calculated and output using the search area full data that are stored in the current picture storage unit 20 and the previous picture storage unit 30, like the H.264 standard (S40).

On the other hand, in the set mode, the motion compensation is performed on the macroblock data of the current pictures and then, the compensation SAD (SADmcp) is calculated (S60).

In addition, in the case of the set mode, the intermediate SAD (SADmed) and the intermediate motion vector (MVmed) are calculated using the SADs and the intermediate value of the motion vectors for the macroblocks neighboring to the macroblocks of the current pictures and the macroblocks of the previous pictures (S70).

In this case, the neighboring macroblocks indicate the left portion A, the top portion B, and the top right portion C of the macroblock X of the current picture, as illustrated in FIG. 3. The macroblock D of the previous picture indicates the same position as the macroblock X of the current picture.

Therefore, the intermediate SAD (SADmed) as the intermediate value of SADa, SADb, SADc, and SADd that are the SADs for the neighboring macroblocks and the macroblocks of the previous pictures and the intermediate motion vector (MVmed) as the intermediate value of MVa, MVb, MVc, and MVd that are the motion vectors are calculated.

Hereinafter, if it is determined that the compensation SAD (SADmcp) is small by comparing the compensation SAD (SADmcp) with the intermediate SAD (SADmed), the intermediate motion vector (MVmed) is output to determine the early termination and the intermediate motion vector (MVmed) is used for the motion estimation (S80) (S90).

The motion estimation has high correlation between the neighboring screens of the video signals and the compression efficiency of the video signals may be increased by reducing redundant information that is present on a time base.

On the other hand, if it is determined that the compensation SAD (SADmcp) is small by comparing the compensation SAD (SADmcp) with the intermediate SAD (SADmed), the SADs and the motion vectors are calculated and output by the full search method using the search area full data that are stored in the current picture storage unit 20 and the previous picture storage unit 30 as in the H.264 standard.

For example, provided that the 64×64 macroblocks occupy 50% by the coding units per a frame, when the motion estimation for each coding unit is performed in accordance with the embodiment of the present invention, which may reduce the memory bandwidth access about 50% as compared with the full search method.

As described above, the motion estimation method in accordance with the embodiment of the present invention can calculate the SADs for only the macroblocks of the current pictures when the modes of the coding units are the 64×64 and 32×32 modes to determine the early termination and estimate the motions using the intermediate motion vectors to minimize the area of hardware and reduce the memory access.

In accordance with the embodiments of the present invention, it is possible to reduce the external memory access in an area in which the macroblocks are large while preventing the image quality from deteriorating due to the motion estimation according to the coding units, by obtaining the minimum motion vector using the prediction method in the 64×64 and 32×32 modes for the coding units meeting the high efficiency video coding (HEVC) standard and obtaining the motion vectors using the full search method in other modes.

Although the embodiments of the present invention have been described in detail, they are only examples. It will be appreciated by those skilled in the art that various modifications and equivalent other embodiments are possible from the present invention. Therefore, the technical protection scope of the present invention should be defined by the appended claims.

What is claimed is:

1. A motion estimation apparatus, comprising:
a calculation unit configured to calculate sum of absolute difference (SADs) and motion vectors based on current pictures and previous pictures;
a compensation intermediate calculation unit configured to calculate and output intermediate motion vectors for the current pictures and the previous pictures; and
a control unit configured to control the calculation unit and the intermediate compensation calculation unit according to modes of coding units and perform a control to optionally output the motion vectors or the intermediate motion vectors according to output results of the compensation intermediate calculation unit.

2. The motion estimation apparatus of claim 1, wherein the control unit controls the compensation intermediate calculation unit when the coding units are 64×64 and 32×32 modes.

3. The motion estimation apparatus of claim 1, wherein the compensation intermediate calculation unit includes:
a compensation unit configured to compensate for motions for the current pictures and calculate a compensation SAD;
an intermediate value calculation unit configured to calculate an intermediate SAD and intermediate motion vectors using SADs and intermediate values of motion vectors for macroblocks neighboring to macroblocks of the current pictures and macroblocks of the previous pictures; and
a comparison unit configured to output results obtained by comparing the intermediate SAD calculated by the intermediate value calculation unit with the compensation SAD calculated by the compensation unit, and to output the intermediate motion vectors calculated by the intermediate value calculation unit.

4. The motion estimation apparatus of claim 3, wherein the comparison unit outputs the intermediate motion vectors when the compensation SAD is smaller than the intermediate SAD.

5. The motion estimation apparatus of claim 3, wherein the control unit controls to output the intermediate motion vector output from the comparison unit when the compensation SAD is smaller than the intermediate SAD according to the comparison results of the comparison unit.

6. The motion estimation apparatus of claim 3, wherein the neighboring macroblocks include a left portion, a top portion, and a top right portion of the macroblock of the current picture.

7. The motion estimation apparatus of claim 1, wherein the control unit reads macroblock data or search area full data as the current pictures and the previous pictures according to the coding units.

8. A motion estimation method, comprising:
receiving, by a control unit, modes of coding units to determine what modes are set so as to read macroblock data or search area full data for current pictures and previous pictures;
calculating motion compensation and a compensation SAD for the macroblock data of the current pictures when the modes of the coding units are the set modes;
calculating an intermediate SAD and intermediate motion vectors using SADs and intermediate values of motion vectors for macroblocks neighboring to macroblocks of the current pictures and macroblocks of the previous pictures; and
outputting the intermediate motion vectors if it is determined that the compensation SAD is smaller according to results obtained by comparing the compensation SAD with the intermediate SAD.

9. The motion estimation method of claim 8, further comprising: calculating and outputting the SADs and the motion vectors based on the search area full data when the modes of the coding units are modes other than the set modes and the compensation SAD is larger according to results obtained by comparing the compensation SAD with the intermediated SAD.

10. The motion estimation method of claim 8, wherein the set modes are 64×64 and 32×32 modes.

11. The motion estimation method of claim 8, wherein the neighboring macroblocks include a left portion, a top portion, and a top right portion of the macroblock of the current picture.
